(19) United States
(12) Patent Application Publication
(10) Pub. No.: US 2010/0027396 A1
(43) Pub. Date: Feb. 4, 2010

(54) DROP-OUT DETECTING CIRCUIT AND OPTICAL DISC DEVICE

(76) Inventor: Junichi Minamino, Nara (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/096,945

(22) PCT Filed: Jan. 12, 2007
(86) PCT No.: PCT/JP2007/050329

§ 371 Date: Jun. 11, 2008

(30) Foreign Application Priority Data
Jan. 19, 2006 (JP) 2006-010910

(51) Int. Cl. G11B 20/18

(52) U.S. Cl. 369/53.12; G9B/20.046

(57) ABSTRACT

An optical disc apparatus according to the present invention includes: an optical head 102 that irradiates a given optical disc 101 with a light beam and generates electrical signals based on light reflected from the optical disc; a dropout detecting section 108 for detecting a dropout that has occurred in the reflected light intensity by comparing the level of one of the electrical signals that represents the reflected light intensity to a slice level; and a management information reading section 115 for determining whether each information storage layer of the given optical disc is an L to H type, in which the recording marks have a higher reflectance than an unrecorded area, or an H to L type, in which the recording marks have a lower reflectance than the unrecorded area. And the slice level is defined based on the result of the decision.

### TECHNICAL FIELD

The present invention relates to a circuit for detecting defects in a read signal from an optical disc and also relates to an optical disc apparatus including such a circuit.

### BACKGROUND ART

Data stored on an optical disc can be read out from the disc by irradiating the rotating disc with a relatively weak light beam with a constant intensity, and detecting the light that has been modulated by, and reflected from, the optical disc.

On a read-only optical disc, information is already stored as pits that are arranged spirally during the manufacturing process of the optical disc. On the other hand, on a rewritable optical disc, a recording material film, from/on which data can be read and written optically, is deposited by an evaporation process, for example, on the surface of a base material on which tracks with spiral lands or grooves are arranged. In writing data on such a rewritable optical disc, data is written there by irradiating the optical disc with a light beam, of which the optical power has been changed according to the data to be written, and locally changing the properties of the recording material film. More specifically, by irradiating the disc with a relatively intense light beam while changing its intensities, rows of “recording marks” with various lengths are formed on the recording material film along the tracks. The other portions of the recording material film, where no recording marks have been made, i.e., portions between two adjacent recording marks on the tracks, become “spaces”.

For example, a phase change optical disc is shipped with its recording material film initialized into a crystalline state during its manufacturing process. Data is written there by changing the light beams from a relatively intense one into a relatively weak one, or vice versa. A portion that has been irradiated with a relatively intense light beam is rapidly cooled after having been heated, thus forming an amorphous recording mark. On the other hand, a portion that has been irradiated with a relatively weak light beam is gently cooled after having been heated, and therefore, is crystallized. As will be described later, a normal phase change recording film has a lower reflectance in the amorphous state than in the crystalline state (i.e., initial state, or unrecorded state). That is why by taking advantage of such a difference in reflectance, data can be read.

It should be noted that the depth of the grooves and the thickness of the recording material film are much smaller than the thickness of the optical disc base material. For that reason, those portions of the optical disc, where data is stored, define a two-dimensional plane, which is sometimes called a “storage plane”. However, considering that such a storage plane actually has a physical dimension in the depth direction, too, the term “storage plane” will be replaced herein by another term “information storage layer”. Every optical disc has at least one such information storage layer. Optionally, a single information storage layer may actually include a plurality of layers such as a phase-change material layer and a reflective layer.

As described above, to read or write data optically from/on a rotating optical disc, an optical disc apparatus needs to irradiate a target track on the optical disc with a light beam, which can be done using a small “optical head” including built-in light source and photodetector.

An optical head is a part of an optical disc apparatus, and can move back and forth straight along the radius of an optical disc that is mounted on a disc motor in the optical disc apparatus, thereby accessing an arbitrary track on the optical disc. An optical head normally includes a semiconductor laser that emits a light beam as a light source, an objective lens that converges the light beam emitted from the semiconductor laser onto the optical disc, and an actuator that can change the positions of the objective lens in response to a drive signal supplied from a control section. The optical head also includes a photodetector to receive the light beam that has been reflected from the optical disc and then transmitted through the objective lens. Based on the light beam (or reflected light) received at its photosensitive area, the photodetector can generate various electrical signals such as a read signal, a focus error signal, and a tracking error signal. These electrical signals are sent from the optical head to an integrated circuit such as a front-end processor in the optical disc apparatus.

The optical head operates integrally on a drive mechanism (which is also called a “traverse mechanism”) in the optical disc apparatus, and is moved along the radius of the optical disc by the traverse mechanism. The position of the objective lens in the optical head is accurately controlled by the actuator in the optical head as described above.

To write data on a rewritable optical disc or to read data that is stored on such an optical disc, the light beam always needs to maintain a predetermined converging state on the target track on the information storage layer. For that purpose, a “focus control” and a “tracking control” are required. The “focus control” means controlling the position of the objective lens perpendicularly to the information storage layer such that the focus position of the light beam is always located on the information storage layer. On the other hand, the “tracking control” means controlling the position of the objective lens along the radius of a given optical disc (which direction will be referred to herein as a “disc radial direction”) such that the light beam spot is always located right on the target track.

Various types of optical discs such as DVD (digital versatile disc)-ROM, DVD-RAM, DVD-RW, DVD-R, DVD+RW and DVD+R have become more and more popular these days as storage media on which a huge amount of information can be stored at high densities. Meanwhile, CDs (compact discs) are still popular now. Recently, next-generation optical discs such as Blu-ray Discs (BDs), on which an even greater amount of information can be stored at much higher densities than those optical discs, have been under research and development.

These numerous types of optical discs have various physical structures. For example, the physical structures and pitches of their tracks and the depths of their information storage layer (i.e., the distance from the light incoming side of the optical disc to that information storage layer) could be different from each other. To read/write data from/on multiple types of optical discs with such different physical structures, the information storage layer of a given optical disc needs to be irradiated with a light beam with an appropriate wavelength using an optical system that has a numerical aperture (NA) associated with the type of the optical disc. If a single optical disc apparatus needs to be compatible with those multiple types of optical discs, a plurality of light sources with mutually different wavelengths and/or a plurality of objective lenses with respectively different numerical apertures may be provided for a single optical head.

The focus control and tracking control are carried out by irradiating a given optical disc with a light beam and detecting an error signal based on the degree of diffraction of the reflected light. Normally, the objective lens that converges the light beam toward the target track on the target information storage layer is driven such that the error signal, representing the magnitude of error with respect to that target track, becomes as close to zero as possible.

If there is a foreign matter on the surface of a given optical disc or if the light incoming side of the optical disc has any flaw such as a scratch, then the light beam may fail to reach the target information storage layer of the optical disc or may be hardly reflected even if it has reached the target layer. Such a phenomenon is called a “dropout”. Once such a dropout has occurred, no error signals will be generated anymore even if a focus control or tracking control is carried out, thus shattering the stabilities of various types of controls.

Since the dropout will ordinarily last for just a short period of time, the stability of control can often be restored by putting the focus control or tracking control on hold while the dropout persists. And to get such a control done, a technique for detecting a dropout based on the intensity of the light reflected from an optical disc has been developed. As for a recordable optical disc, the dropout needs to be detected not just during reading but also during writing as well.

Patent Document No. 1 discloses a conventional dropout detector. According to that technique, the dropout is detected by comparing a difference between the high-rate envelope and low-rate envelope of a totally reflected signal, generated from the optical disc, at a certain level.

FIG. 9 shows an exemplary configuration for a conventional dropout detector. FIG. 10 shows the waveforms of main signals generated by the dropout detector shown in FIG. 9 in a situation where a dropout has occurred during a read operation.

An all-sum signal S1, calculated based on the light reflected from the optical disc, is supplied to the dropout detector shown in FIG. 9. The all-sum signal S1 is a signal representing the intensity of the light reflected from the optical disc, and has a level that is proportional to the reflectance of an area on the optical disc where the light beam spot is currently located. As shown in portion (a) of FIG. 10, the all-sum signal S1 obtained from an unrecorded area of the optical disc has a high level corresponding to the high reflectance of that unrecorded area. On the other hand, the level of the all-sum signal S1, obtained from a recorded area of the optical disc (i.e., an area where a lot of recording marks have been left to represent the user data), oscillates at high frequencies because the recording marks and spaces have mutually different reflectances in that recorded area.

This all-sum signal S1 is input to the peak envelope detecting section 201 shown in FIG. 9. The peak envelope detecting section 201 detects the peak envelope of the all-sum signal S1, thereby generating a peak envelope signal S2. Then the peak envelope signal S2 is output from the peak envelope detecting section 201 to a low pass filter 202 and a comparator 204. The low pass filter 202 smoothes the peak envelope signal S2 and then passes it to a slice level setting section 203. In response, the slice level setting section 203 changes the levels of the smoothed signal into such a level as to enable dropout detection, thereby generating a slice level S3, which is then supplied to the comparator 204.

The waveform of the all-sum signal S1 shown in portion (a) of FIG. 10 reveals that there could be some scratch in the recorded area, thus decreasing the intensity of the light reflected from that portion. Consequently, a local decrease in the intensity of light (i.e., a dropout) occurred in the all-sum signal S1 shown in portion (a) of FIG. 10.

Portion (b) of FIG. 10 shows the waveforms of the peak envelope signal S2 and slice level S3 that have been supplied to the comparator 204. If a dropout has occurred in the all-sum signal S1, then the level of the peak envelope signal S2 also decreases locally due to the dropout to have a level that is temporarily lower than the slice level S3.

Portion (c) of FIG. 10 shows the waveform of the output signal of the comparator 204. The comparator 204 compares the peak envelope signal S2 to the slice level S3 and detects a steeply depressed portion of the peak envelope signal S2 as a dropout, thereby outputting a dropout detection signal S4.

Such a dropout detector is designed on the supposition that the unrecorded area (i.e., portion in the initialized state) has a relatively high reflectance. In fact, that supposition is confirmed by any of various types of optical discs currently on the market, including DVD-Rs, DVD-RWs, DVD-RAMs, BD-REs and BD-Rs (with an inorganic recording film).

However, some optical discs do have a low reflectance in the initialized state and recording marks with a relatively high reflectance. For example, in an organic dye recording film, which is being developed for BD-Rs and HD DVD-Rs, the reflectance is higher in its recorded area than in its unrecorded area. Such an optical disc, of which the reflectance is higher in its recorded area than in its unrecorded area, will be referred to herein as a “low to high (L to H) type optical disc”. An L to H type optical disc is disclosed in Patent Document No. 2, for example. On the other hand, a conventional optical disc, of which the reflectance is lower in its recorded area than in its unrecorded area, will be referred to herein as a “high to low (H to L) type optical disc”.

FIG. 11(a) shows the waveform of an all-sum signal S1 obtained from an L to H type optical disc, while FIG. 11(b) shows the waveform of an all-sum signal S1 obtained from an H to L type optical disc.
Patent Document No. 1: Japanese Patent Application Laid-Open Publication No. 2003-132533
Patent Document No. 2: Japanese Patent Application Laid-Open Publication No. 2003-323744

### DISCLOSURE OF INVENTION

### Problems to be Solved by the Invention

Portions (a) through (c) of FIG. 12 show exemplary waveforms of signals to be generated when an L to H type optical disc is played with the conventional dropout detector shown in FIG. 9. Specifically, portion (a) of FIG. 12 shows the waveform of an all-sum signal S1, portion (b) of FIG. 12 shows the waveforms of peak envelope signal S2 and slice level S3 that are supplied to the comparator 204, and portion (c) of FIG. 12 shows the waveform of the output signal of the comparator 204.

If the all-sum signal S1 obtained from the L to H type optical disc is supplied to the circuit shown in FIG. 9, the level of the peak envelope signal S2 rises steeply when the light beam spot enters the recorded area from the unrecorded area as shown in portion (b) of FIG. 12. This is because the L to H type optical disc has a low reflectance in its unrecorded area and a high reflectance in its recorded area as shown in portion (a) of FIG. 12. Comparing the two peak envelope signals S2 shown in respective portions (b) of FIGS. 10 and 12 to each other, it can be seen easily that the peak envelope signal S2 shown in portion (b) of FIG. 10 maintains a high level even in the unrecorded area and its level does not decrease so much even when the light beam spot moves from the unrecorded area into the recorded area. On the other hand, the peak envelope signal S2 shown in portion (b) of FIG. 12 has a low level in the unrecorded area but its level rises steeply when the light beam spot enters the recorded area.

In the dropout detector shown in FIG. 9, the slice level S3 is generated by getting the peak envelope signal S2 smoothed by the low pass filter 202. For that reason, the slice level S3 hardly changes between the unrecorded and recorded areas in the H to L type optical disc as shown in portion (b) of FIG. 10. In the L to H type optical disc, on the other hand, the peak envelope signal S2 changes steeply as shown in portion (b) of FIG. 12, and the slice level S3 changes accordingly. Due to the time constant of the low pass filter 202 that should smooth the peak envelope signal S2, the slice level S3 cannot follow the peak envelope signal S2 so quickly. That is why the slice level S3 tries to catch up with the peak envelope signal S2 while rising slowly as shown in portion (b) of FIG. 12. However, since the follow-up rate is low, the slice level S3 cannot reach what it is supposed to be immediately after the light beam spot has entered the recorded area from the unrecorded area, but has a level somewhat lower than the best slice level for a while. If a dropout occurred during that interval, such a dropout could not be detected properly. Nevertheless, if the time constant of the low pass filter 202 were decreased, then the peak envelope signal S2 could not be smoothed sufficiently. In that case, if a dropout occurred as shown in portion (b) of FIG. 10, the slice level S3 would also decrease temporarily along with the dropout. As a result, the dropout could not be detected as intended.

There is another problem with the dropout detector described above. That problem arises when the light beam spot leaves the recorded area to enter the unrecorded area after the slice level S3 has followed the peak envelope signal S2 in the recorded area to reach a sufficiently high level as shown in portion (b) of FIG. 12. Specifically, when the light beam spot moves from the recorded area into the unrecorded area, the peak envelope signal S2 drops steeply. Meanwhile, due to the operation of the low pass filter 202 described above, the slice level S3 cannot follow the decline of the peak envelope signal S2 so quickly but decreases slowly. In this case, if the peak envelope signal S2 became lower than the slice level S3, a dropout could be detected by mistake.

As described above, in the conventional dropout detector, since the slice level S3 cannot respond so quickly when the light beam spot enters the recorded area of an L to H type optical disc from an unrecorded area thereof, no dropout can be detected at an appropriate slice level S3 until a certain amount of time passes. In addition, when the light beam spot leaves the recorded area to enter the unrecorded area after the slice level S3 has risen sufficiently, the steep decline in the level of the peak envelope signal S2 could be detected as a dropout by mistake.

In order to overcome the problems described above, the present invention has an object of providing an optical disc apparatus that can detect a dropout properly even when an L to H type optical disc is being played.

### Means for Solving the Problems

An optical disc apparatus according to the present invention can read and/or write data from/on an optical disc on which the data is stored by making a plurality of recording marks on a track. The apparatus includes: an optical head that irradiates a given optical disc with a light beam and generates electrical signals based on light reflected from the optical disc; a dropout detecting section for detecting a dropout that has occurred in the reflected light intensity by comparing the level of one of the electrical signals that represents the reflected light intensity to a slice level; and a decision section for determining whether each information storage layer of the given optical disc is a first type, in which the recording marks have a higher reflectance than an unrecorded area, or a second type, in which the recording marks have a lower reflectance than the unrecorded area. Either a bottom envelope or a peak envelope of the reflected light intensity is selected in accordance with the decision made by the decision section and the slice level is defined based on the envelope selected.

In reading data from a target information storage layer of the given optical disc, if the information storage layer is the first type, the slice level is defined based on the bottom envelope of the reflected light intensity. But if the information storage layer is the second type, the slice level is defined based on the peak envelope of the reflected light intensity.

In one preferred embodiment, in writing data on the target information storage layer of the given optical disc, the slice level is always defined based on the peak envelope of the reflected light intensity, no matter whether the information storage layer is the first type or the second type.

In another preferred embodiment, the dropout detecting section includes: an envelope detecting section for detecting either the peak envelope or the bottom envelope based on the reflected light intensity to generate an envelope signal representing either the peak envelope or the bottom envelope; a low pass filter for smoothing the envelope signal; a slice level setting section for defining a slice level based on the output of the low pass filter; and a comparator for comparing the level of the envelope signal to the slice level and outputting a dropout detection signal in finding the level of the envelope signal lower than the slice level.

In this particular preferred embodiment, the low pass filter includes a time constant changing section for smoothing the envelope signal with different time constants. If the envelope detecting section is generating an envelope signal representing the peak envelope, then the time constant changing section temporarily decreases the time constant synchronously with the change of modes of operation from reading into writing, or vice versa.

In another preferred embodiment, when the dropout detecting section detects a dropout that has occurred in the reflected light intensity, at least one of a focus servo control and a tracking servo control on the information storage layer is put on hold.

In still another preferred embodiment, in a situation where the envelope detecting section is generating an envelope signal representing the peak envelope, even if the level of the envelope signal becomes lower than the slice level, neither the focus servo control nor the tracking servo control on the information storage layer is put on hold during a predetermined period that is synchronized with the changes of modes of operations between reading and writing.

In yet another preferred embodiment, if the given optical disc has multiple information storage layers, it is determined, in accordance with the decision made by the decision section, whether a target one of the information storage layers, on which a read/write operation needs to be carried out, is the first type or the second type and the slice levels are defined for the respective information storage layers.

A dropout detector according to the present invention is designed to detect a dropout that has occurred in the intensity of light reflected from an information storage layer of an optical disc by comparing the level of a signal representing the reflected light intensity to a slice level. The detector includes: an envelope detecting section for detecting either a peak envelope or a bottom envelope based on the reflected light intensity to generate an envelope signal representing either the peak envelope or the bottom envelope; a low pass filter for smoothing the envelope signal; a slice level setting section for defining a slice level based on the output of the low pass filter; and a comparator for comparing the level of the envelope signal to the slice level and outputting a dropout detection signal in finding the level of the envelope signal lower than the slice level. In performing a read operation on an information storage layer of a first type, in which recording marks have a higher reflectance than an unrecorded area, the envelope detecting section generates an envelope signal representing the bottom envelope based on the reflected light intensity. But in performing a read operation on an information storage layer of a second type, in which the recording marks have a lower reflectance than the unrecorded area, the envelope detecting section generates an envelope signal representing the peak envelope based on the reflected light intensity.

In one preferred embodiment, the low pass filter includes a time constant changing section for smoothing the envelope signal with different time constants. If the envelope detecting section is generating an envelope signal representing the peak envelope, then the time constant changing section temporarily decreases the time constant synchronously with the change of modes of operation from reading into writing, or vice versa.

### Effects of the Invention

According to the present invention, the slice levels can be changed by determining whether the given optical disc is an L to H type or an H to L type. That is why even if the given optical disc is an L to H type, the slice level can also be defined appropriately. As a result, the dropout can be detected accurately, no matter what type of optical disc has been given.

### BRIEF DESCRIPTION OF DRAWINGS

FIG. 1 illustrates the appearance of an optical disc for use in a preferred embodiment of the present invention.

FIG. 2 is a block diagram showing an optical disc apparatus as a preferred embodiment of the present invention.

FIG. 3 is a block diagram showing a dropout detector as a preferred embodiment of the present invention.

FIG. 4 shows main signals for use in a dropout detector as a preferred embodiment of the present invention in a situation where the given optical disc is an L to H type.

Portions (a) through (c) of FIG. 5 show how to detect a dropout during reading according to a preferred embodiment of the present invention.

FIG. 6 shows how to detect a dropout during writing according to a preferred embodiment of the present invention.

FIG. 7 shows main signals for use in a dropout detector as a preferred embodiment of the present invention in a situation where the given optical disc is an H to L type.

FIG. 8 is a flowchart showing the procedure of processing to be done in a preferred embodiment of the present invention.

FIG. 9 shows a configuration for a conventional dropout detector.

Portions (a) through (c) of FIG. 10 show main signals for use in the conventional dropout detector.

FIGS. 11(a) and 11(b) show a signal generated from an L to H type optical disc and a signal generated from an H to L type optical disc, respectively.

Portions (a) through (c) of FIG. 12 show main signals for use in the conventional dropout detector in a situation where the dropout detector plays an L to H type optical disc.

### DESCRIPTION OF REFERENCE NUMERALS

202 low pass filter
203 slice level setting section
204 comparator
206 edge detecting section
207 time constant switching signal setting section
208 resistor
209 capacitor
210 buffer
211 time constant changing section
212 envelope detecting section
213 envelope setting section
S1 all-sum signal
S2 peak envelope signal
S3 slice level
S4 dropout detection signal
S5 read/write mode switching signal
S6 write edge signal
S7 envelope setting signal
S8 envelope signal
S9 L to H type recognition signal

### BEST MODE FOR CARRYING OUT THE INVENTION

An optical disc apparatus according to the present invention can read and/or write data from/on an optical disc. The apparatus includes: an optical head that irradiates a given optical disc with a light beam and generates electrical signals based on light reflected from the optical disc; and a dropout detecting section for detecting a dropout that has occurred in the reflected light intensity by comparing the level of one of the electrical signals generated by the optical head, which represents the reflected light intensity, to a slice level.

The dropout detecting section of the present invention is characterized by changing the slice levels by determining whether the given optical disc is an L to H type optical disc or an H to L type optical disc. The conventional dropout detecting section sets the same slice level by the same method, no matter whether the given optical disc is an L to H type optical disc or an H to L type optical disc, thus causing the problems described above. According to the present invention, however, the slice levels can be changed according to the type of the given optical disc, i.e., by recognizing it as either an L to H type or an H to L type. As a result, such problems can be overcome.

In a preferred embodiment of the present invention, when a read operation is performed on an L to H type optical disc, a slice level is generated based on the bottom envelope of an all-sum signal. In the other cases, a slice level is generated based on the peak envelope of the all-sum signal as shown in the following Table 1:

TABLE 1

| | Read | Write |
|---|---|---|
| L to H | Bottom envelope | Peak envelope |
| H to L | Peak envelope | Peak envelope |

In an L to H type optical disc, the unrecorded area thereof has a low reflectance but the recorded area thereof has an increased reflectance. However, the magnitude of the bottom envelope of the all-sum signal obtained from the recorded area is almost the same as that of the all-sum signal obtained from the unrecorded area. For that reason, if the slice level is defined based on the bottom envelope of the all-sum signal, the slice level hardly varies even at the boundary between the unrecorded and recorded areas, thus overcoming the problem with the conventional dropout detector.

Also, in preferred embodiments of the present invention to be described below, when the modes of operation are changed from reading into writing, or vice versa, the response speed of a low pass filter, which is used to smooth the peak envelope of the all-sum signal, is temporarily increased, thereby overcoming another problem with the conventional dropout detector in terms of the slow response of the slice level.

To carry out these operations, an optical disc apparatus according to the present invention preferably includes means for determining whether the given optical disc is an L to H type or an H to L type and means for controlling the response characteristic of the low pass filter when the modes of operation are changed from reading into writing, or vice versa, to generate a slice level.

### Embodiment

Hereinafter, preferred embodiments of the present invention will be described with reference to the accompanying drawings.

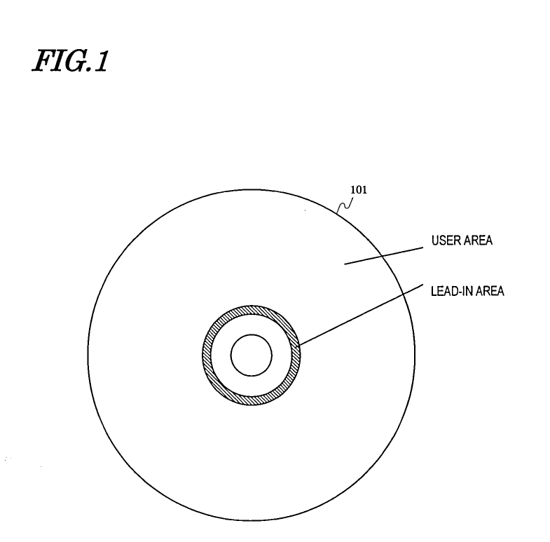

First of all, an optical disc 101 that can be used effectively in an optical disc apparatus according to the present invention will be described with reference to FIG. 1.

The optical disc 101 for use in this preferred embodiment is a recordable optical disc such as a BD-R or a BD-RE. On the optical disc 101, arranged as the innermost area is a lead-in area, which is surrounded with a user area where a continuous groove track is arranged spirally. In the lead-in area, management information for the optical disc 101, including physical information and copyright protection information, is stored in advance. The management information includes a piece of information about a recording property of the information storage layer of the optical disc 101 (i.e., whether the layer is an L to H type or an H to L type).

Optionally, the optical disc 101 may include multiple information storage layers. Such an optical disc will be referred to herein as a “multilayer optical disc”. It should be noted, however, that not all of those information storage layers included in a single multilayer optical disc have to be an L to H type or an H to L type. In other words, a single multilayer optical disc may include both an L to H type information storage layer and an H to L type information storage layer. That is why management information for such a multilayer optical disc preferably includes a piece of information that can be used to recognize each of its own information storage layers to be an L to H type or an H to L type.

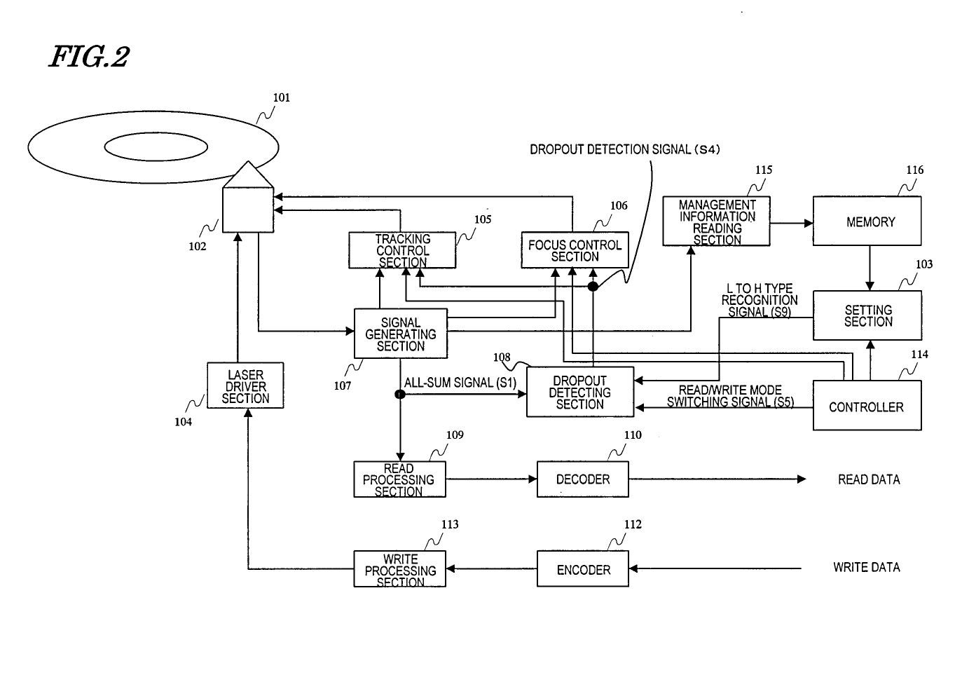

Next, a configuration for an optical disc apparatus as a preferred embodiment of the present invention will be described with reference to FIG. 2.

The optical disc apparatus of this preferred embodiment includes an optical head 102, a dropout detecting section 108 and other components shown in FIG. 2.

When this optical disc apparatus is loaded with the optical disc 101, the optical head 102 irradiates the optical disc 101 with a light beam. The optical head 102 may have the same configuration as a known optical head. Specifically, the optical head 102 includes a light source such as a semiconductor laser (not shown), an objective lens that converges the light beam emitted from the light source, an actuator to drive the objective lens, a photodetector, and other components.

The optical head 102 can move back and forth straight along the radius of the optical disc 101, thereby accessing an arbitrary track on the optical disc 101. The optical head 102 operates integrally on a drive mechanism (not shown) in the optical disc apparatus, and is moved along the radius of the optical disc 101 by a traverse mechanism. The position of the objective lens (not shown) in the optical head 101 is accurately controlled by the actuator in the optical head 102 as described above.

The light beam reflected from the optical disc 101 is then incident on the photodetector (not shown) included in the optical head 102. The photodetector performs photoelectric conversion on the incoming reflected light, thereby generating various types of electrical signals. The photodetector of this preferred embodiment is divided into four areas by a division line that is drawn parallel to the track groove direction (corresponding to the tangential direction) on the optical disc 101 and by another division line that is drawn parallel to the radial direction on the optical disc 101. Each of those four divided areas outputs a voltage signal representing the intensity of the light that has been incident there.

Those voltage signals are output from the photodetector in the optical head 102 to a signal generating section 107, which generates, based on the voltage signals, an all-sum signal, a focus error signal, and a tracking error signal and outputs them. Specifically, the all-sum signal is obtained by adding together all of those four output signals of the quadruple photodetector, and represents the intensity itself of the light reflected from the optical disc. The focus error signal may be detected by an astigmatism method, for example, and obtained by adding together the output signals of each diagonal pair of photosensitive areas of the quadruple photodetector and by calculating the difference between the two sums. And the tracking error signal may be detected by a push-pull method, and obtained by adding together the output signals of each tangential pair of photosensitive areas of the quadruple photodetector and by calculating the difference between the two sums.

A focus control section 106 drives the objective lens (included in the optical head 102) up and down in response to the focus error signal generated by the signal generating section 107, thereby controlling the position of the objective lens such that the focal point is located right on the information storage layer of the optical disc 101. If the given optical disc is a multilayer optical disc, the focus control section 106 controls the position of the objective lens in accordance with the instruction given by a controller 114 such that the focal point is located on a target one of the information storage layers.

A tracking control section 105 drives the objective lens, included in the optical head 102, radially in response to the tracking error signal generated by the signal generating section 107, thereby controlling the position of the objective lens such that the light beam can follow the track groove on the optical disc 101. The tracking control section 105 is provided with address information, which can be used to locate the target track on which the light beam should be focused, by the controller 114.

A management information reading section 115 reads the management information that is stored in the lead-in area of the optical disc 101 and stores a piece of information, indicating whether the given optical disc 101 is an H to L type optical disc or an L to H type optical disc, in a memory 116. If the given optical disc is a multilayer optical disc, then the management information reading section 115 stores that piece of information about the type (which may be either the H to L type or the L to H type) in the memory 116 on a layer-by-layer basis.

A setting section 103 is provided with the information about the type of each information storage layer (i.e., an L to H property or an H to L property) by the memory 116 and is also provided with the information about the information storage layer on which the focus control section 106 is now controlling the focal point of the light beam by the controller 114, thereby outputting an L to H type recognition signal S9 about the type of the information storage layer on which a read/write operation needs to be performed. Specifically, if the information storage layer as a target of the read/write operation has the L to H property, the L to H type recognition signal S9 output from the setting section 103 is one. On the other hand, if the information storage layer has the H to L property, then the L to H type recognition signal S9 output from the setting section 103 becomes zero.

A dropout detecting section 108 detects a dropout that has occurred on the optical disc 101 based on the all-sum signal S1 generated by the signal generating section 107, and outputs a dropout detection signal S4 to the focus control section 106 and the tracking control section 105. The detailed configuration of the dropout detecting section 108 will be described later.

When the dropout detecting section 108 detects a dropout and outputs the dropout detection signal S4, the focus control section 106 and the tracking control section 105 open their control loops and put hold on the drive of the objective lens in the optical head 102. Alternatively, the dropout detection signal S4 may also be used to put hold on a read PLL or any other purpose. If the lens tilt is being controlled adaptively, the tilt control may also be put on hold.

In reading user data from the optical disc 101, a read processing section 109 performs an automatic gain control (AGC), a waveform equalization and clock generation on the all-sum signal S1 that has been generated by the signal generating section 107, thereby converting the stored data into digital data. A decoder 110 subjects the output of the read processing section 109 to demodulation, error correction and de-scrambling, thereby outputting read data to a host computer.

In writing user data on the optical disc 101, an encoder 112 subjects the write data, received from the host computer (not shown), to scrambling, addition of error correction code and modulation, thereby generating an encoded write signal. A write processing section 113 receives the write signal from the encoder 112 and subjects it to multi-pulse generation and write compensation processing to generate a laser activating pulse signal. A laser driver section 104 receives the laser activating pulse signal from the write processing section 113 and modulates the intensity of the light beam. The power of the light beam to write data (which is often called a “recording power”) may be 4.5 mW on average, for example.

When these operations are performed, the controller 114 outputs a read/write mode switching signal S5 to each section that needs to change the types of processing according to the mode of operation requested, which may be read, write or standby, thereby controlling those sections such that they can operate properly.

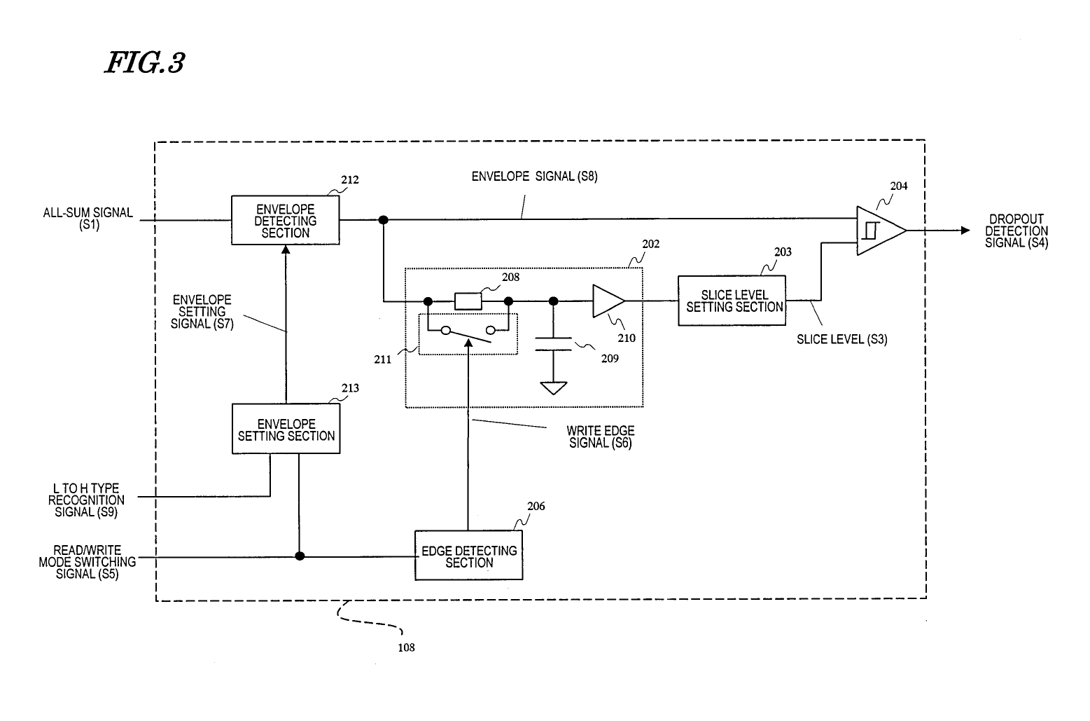

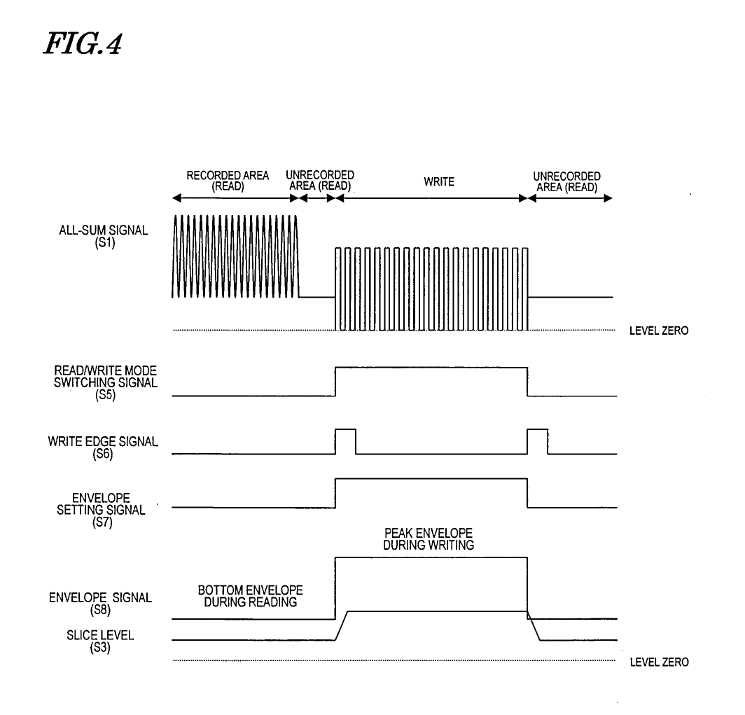

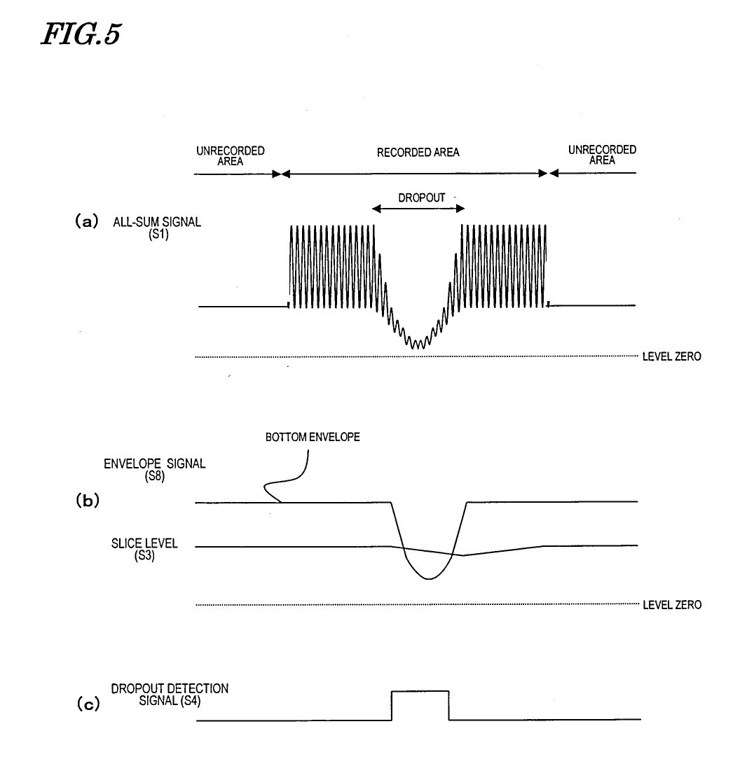

Hereinafter, the configuration and operation of the dropout detecting section 108 of this preferred embodiment will be described with reference to FIGS. 3 and 4. FIG. 3 shows an exemplary internal configuration for, the dropout detecting section 108. FIG. 4 shows typical waveforms of main signals for use in the dropout detecting section 108.

Look at FIG. 3, first. The dropout detecting section 108 shown in FIG. 3 includes an envelope detecting section 212 for detecting the envelope of the all-sum signal S1 to generate an envelope signal S8, a low pass filter 202 and a slice level setting section 203 for generating a slice level based on the envelope signal S8, and a comparator 204 that compares the envelope signal S8 and the slice level S3 to each other. The dropout detecting section 108 further includes an envelope setting section 213 that outputs an envelope setting signal S7 to determine, according to the situation shown in Table 1, whether the envelope to be detected from the all-sum signal S1 is a peak envelope or a bottom envelope, and an edge detecting section 206 for detecting an edge (or a variation point) of the read/write mode switching signal S5 and generating a write edge signal S6 to change the time constants of the low pass filter 202.

When the signal generating section 107 shown in FIG. 2 supplies the all-sum signal S1 to the dropout detecting section 108 of this preferred embodiment, the all-sum signal S1 is given to the envelope detecting section 212 shown in FIG. 3 first. If the envelope setting signal S7 is one, the envelope detecting section 212 detects the peak envelope of the all-sum signal S1 and outputs the peak envelope of the all-sum signal S1 as the envelope signal S8. On the other hand, if the envelope setting signal S7 is zero, the envelope detecting section 212 detects the bottom envelope of the all-sum signal S1 and outputs the bottom envelope of the all-sum signal S1 as the envelope signal S8. In any case, the envelope signal S8 is output from the envelope detecting section 212 to the low pass filter 202 and the comparator 204.

The low pass filter 202 includes a resistor 208, a capacitor 209 and a buffer 210, and performs the function of smoothing the envelope signal S8. That is to say, even if a dropout signal is included in the all-sum signal S1, the low pass filter 202 does not respond to that dropout but smoothes the signal S8 with a time constant of 10 ms, for example, which is a response approximately as long as one cycle of a variation in reflectance around the disc.

The time constant τ of the low pass filter 202 is calculated by τ=RC, where R is the resistance value of the resistor 208 and C is the capacitance value of the capacitor 209, and its cutoff frequency is calculated by 1/(2πτ). The low pass filter 202 further includes a switch 211 (time constant changing section), which is connected in parallel to the resistor 208. The function of the time constant changing section 211 will be described later.

The envelope signal that has been smoothed by the low pass filter 202 is input to the slice level setting section 203, which produces a slice level based on the smoothed envelope signal. More specifically, the slice level setting section 203 reduces the amplitude of the smoothed envelope signal to a half, for example, with respect to the zero level, thereby outputting a slice level signal S3. In this preferred embodiment, the amplitude of the smoothed envelope signal is divided by the factor of two. However, as long as the dropout can be detected properly at the slice level thus produced, the amplitude may also be divided by any other factor or variable divisors may also be used and changed into the best one at an appropriate timing.

When output from the slice level setting section 203, the slice level signal S3 has already been smoothed sufficiently. That is why the slice level signal S3 has a substantially constant value, no matter whether a dropout has occurred or not. It should be noted that the slice level does not have to be defined just as described above. For example, the slice level may be shifted to a certain degree. Alternatively, the degrees of shift may be changed into the best one at the best timing.

When finding the envelope signal S8 lower than the slice level S3, the comparator 204 outputs a dropout detection signal S4 in logically High state. The level of such a signal in logically High state will be defined herein as “one”, while that of a signal in logically Low state will be defined herein as “zero”. If the level of the envelope signal S8 is equal to or higher than that of the slice level signal S3, the output of the comparator 204 is kept zero.

The envelope setting section 213 outputs an envelope setting signal S7 that becomes zero when the L to H type recognition signal S9 is one and the read/write mode switching signal S5 is zero (which indicates a read mode) but becomes one otherwise. If the given optical disc is a multilayer optical disc, the type of each information storage layer needs to be recognized as H to L type or L to H type on a layer-by-layer basis. In the following description, however, a single layer optical disc will be taken as an example for the sake of simplicity.

If the optical disc apparatus of this preferred embodiment is loaded with an L to H type optical disc, the setting section 103 outputs an L to H type recognition signal S9 in one state. Meanwhile, in a read mode, the read/write mode switching signal S5 is in zero state. That is why in performing a read operation on the L to H type optical disc, the envelope setting section 213 outputs an envelope setting signal S7 in zero state. Consequently, in the read mode, the envelope detecting section 212 detects the bottom envelope of the all-sum signal S1 obtained from the L to H type optical disc and outputs it as an envelope signal S8.

The following Table 2, corresponding to Table 1, summarizes various situations where the envelope setting signal S7 becomes zero or one:

TABLE 2

| | Read | Write |
|---|---|---|
| L to H | Envelope setting | Envelope setting |
| | signal is “zero” | signal is “one” |
| H to L | Envelope setting | Envelope setting |
| | signal is “one” | signal is “one” |

In the write mode, the read/write mode switching signal S5 supplied from the controller 114 becomes one. That is why even if the given optical disc is an L to H type optical disc, the envelope setting section 213 outputs an envelope setting signal S7 in one state. As a result, in the write mode, the envelope detecting section 212 detects the peak envelope of the all-sum signal S1 obtained from the L to H type optical disc and outputs it as an envelope signal S8.

As described above, the envelope detecting section 212 receives the envelope setting signal S7 from the envelope setting section 213. If the envelope setting signal S7 is zero (i.e., if the given optical disc is an L to H type and if the mode of operation is read), the envelope detecting section 212 outputs the bottom envelope of the all-sum signal S1 as an envelope signal S8. On the other hand, if the given optical disc is an H to L type or if the mode of operation is write even though the given optical disc is an L to H type, then the envelope detecting section 212 outputs the peak envelope of the all-sum signal S1 as an envelope signal S8.

The edge detecting section 206 outputs a write edge signal S6 when the read/write mode switching signal S5 changes either from zero into one or from one into zero (i.e., at either a trailing edge or a leading edge). The write edge signal S6 becomes one on one of these two edges but goes zero again in a predetermined amount of time (e.g., 10 μs).

Optionally, with the time for settling the envelope taken into account, a predetermined latency of 10 μs, for example, could be allowed as counted from either a leading edge (i.e., from zero into one) or a trailing edge (i.e., from one into zero) of the read/write mode switching signal S5.

The time constant changing section 211 of the low pass filter 202 is connected in parallel to the resistor 208, and is opened if the write edge signal S6 supplied from the edge detecting section 206 is zero but short-circuited if the write edge signal S6 supplied from the edge detecting section 206 is one. When the write edge signal S6 rises from zero to one to short-circuit the time constant changing section 211, the resistor 208 is substantially inactivated. In this case, the time constant of the low pass filter given by τ=RC becomes substantially equal to zero. As a result, the capacitor 209 is charged or discharged to the same potential level as the envelope signal S8 in a short time. Thereafter, when the write edge signal S6 goes zero again, the time constant changing section 211 is opened and the time constant of the low pass filter 208 goes back to the level that does not respond to any dropout with the potential level at the charged or discharged capacitor 209 maintained.

Next, referring to FIG. 4, shown are typical waveforms of main signals for use in a situation where the given optical disc is an L to H type optical disc. The waveforms shown in FIG. 4 cover not only a read operation but also a write operation as well. In performing a write operation, a light beam, of which the power has been modulated so as to represent the user data to be written, is emitted from the optical head 102 and irradiates the optical disc 101. In this case, the intensity of the light reflected from the optical disc 101, i.e., the all-sum signal S1, varies at as high frequencies as the power being modulated. No matter whether the given optical disc is an L to H type optical disc or an H to L type optical disc, the power is modulated so as to oscillate back and forth between a relatively high power to make recording marks and approximately zero power. That is to say, during writing, the all-sum signal S1 changes between the high intensity of light reflected from the optical disc being supplied with power that is high enough to leave recording marks and a substantially zero reflected light intensity. In FIG. 4, the peak level of the all-sum signal S1 during writing is illustrated as being lower than that of the all-sum signal S1 during reading. Actually, however, the reflected light intensity during writing is higher than the one during reading.

First, it will be described how the dropout detecting section 108 works during a read operation.

In performing a read operation, the read/write mode switching signal S5 is zero as shown on the left-hand side of FIG. 4. The dropout detecting section 108 is designed so as to output zero as the envelope setting signal S7 if the given optical disc is an L to H type optical disc. Thus, in the read mode, the envelope detecting section 212 (see FIG. 3) detects the bottom envelope of the all-sum signal S1 obtained from the L to H type optical disc and outputs it as an envelope signal S8.

As shown in FIG. 4, in the read mode, the envelope signal S8 is at the bottom envelope level, and the slice level S3 to be produced by reference to the bottom envelope is a relatively low level, too.

As described above, in the L to H type optical disc, the unrecorded area has a low reflectance and the recorded area has an increased reflectance. However, the level of the bottom envelope of the all-sum signal obtained from the recorded area is almost no different from that of the all-sum signal obtained from the unrecorded area as shown in FIG. 4. For that reason, if the slice level is produced based on the bottom envelope of the all-sum signal, the slice level will not vary even at the boundary between the unrecorded and recorded areas and the problem with the conventional dropout detector never happens.

In this preferred embodiment, if a dropout has occurred during a read operation, the envelope signal S8, generated based on the all-sum signal S1, becomes lower than the slice level S3 as shown in portions (a) through (c) of FIG. 5. As a result, the output of the comparator 204 as shown in FIG. 3 (i.e., the dropout detection signal S4) rises from zero to one, thus detecting the dropout.

As described above, according to this preferred embodiment, the slice level S3 is defined based on the bottom envelope of the all-sum signal S1, and therefore, the variation in slice level S3 between the unrecorded and recorded areas such as the one shown in portion (b) of FIG. 12 never arises. That is to say, since the slice level S3 is defined based on the bottom envelope of the all-sum signal S1 that hardly changes between the unrecorded and recorded areas, not the peak envelope thereof that changes significantly between the unrecorded and recorded areas, the problem with the prior art can be resolved.

Next, it will be described how the dropout detecting section 108 works during a write operation.

In performing a write operation, the read/write mode switching signal S5 is one and the envelope setting signal S7 is also one. Thus, in the write mode, the envelope detecting section 212 (see FIG. 3) detects the peak envelope of the all-sum signal S1 obtained from the L to H type optical disc and outputs it as an envelope signal S8.

In the write mode, the all-sum signal S1 also falls to a substantially zero level even if the given optical disc is an L to H type optical disc, as described above. That is why if the bottom envelope were detected, then the envelope signal S8 would become zero. For that reason, according to this preferred embodiment, the peak envelope of the all-sum signal S1 is always detected during writing, no matter whether the given optical disc is an L to H type or an H to L type, and the slice level is defined based on that peak envelope.

As shown in FIG. 4, when the modes of operations are changed from reading into writing, the envelope signal S8 rises from the bottom envelope level to the peak envelope level, and the slice level S3 also rises almost as quickly as the peak envelope level. This is because when the write edge signal S6 is input to the low pass filter 202 on detecting the timing to change the modes of operation from reading into writing, its time constant decreases and the response of the low pass filter is temporarily increased. That is why even if the slice level S3 is defined based on the peak envelope, the slice level S3 can reach the required level quickly, thus overcoming the problem with the conventional dropout detector.

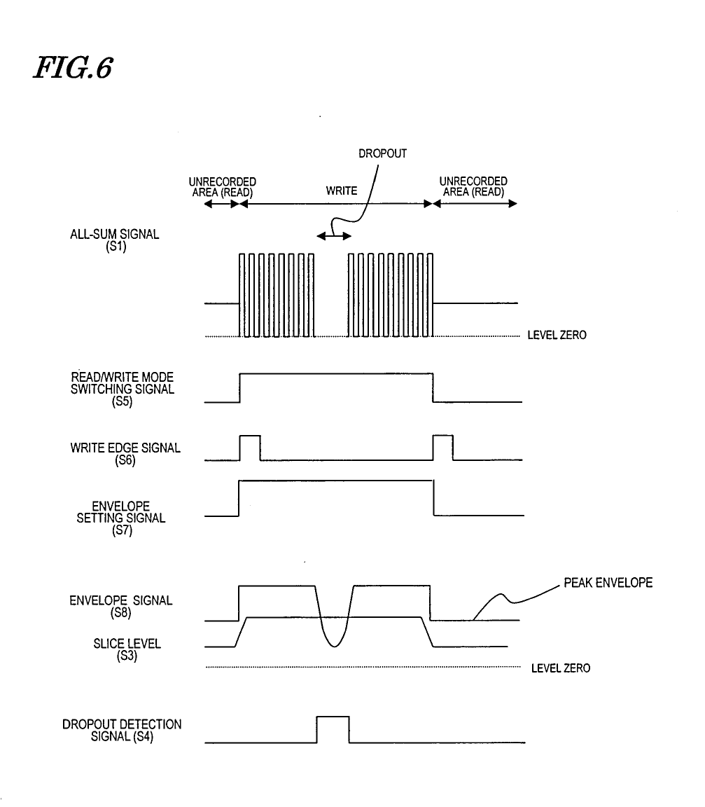

If a dropout has occurred during a write operation, the envelope signal S8, generated based on the all-sum signal S1, becomes lower than the slice level S3 as shown in FIG. 6. As a result, the output of the comparator 204 shown in FIG. 3 (i.e., the dropout detection signal S4) rises from zero to one, thus detecting that dropout.

However, depending on the difference in the level of the envelope signal S8 between the read and write modes, the dropout detection signal S4 could be erroneously detected momentarily when the modes of operations are changed from reading into writing, or vice versa. Even so, by increasing the responsivity of the slice level S3 to a higher level than that of the focus control or tracking control, no problem will arise even if the control is briefly put on hold responsive to the dropout detection signal S4 that has been detected momentarily. It would be even more effective if a masking processing step were additionally performed so as to reduce the dropout detection signal S4 to zero level while the write edge signal S6 is one. By performing such a masking processing step, the dropout detection signal S4 can always maintain the zero level, and no dropout will be detected, at any boundary between the unrecorded and recorded areas. In that case, the focus control and other controls will never be put on hold at any boundary between the unrecorded and recorded areas.

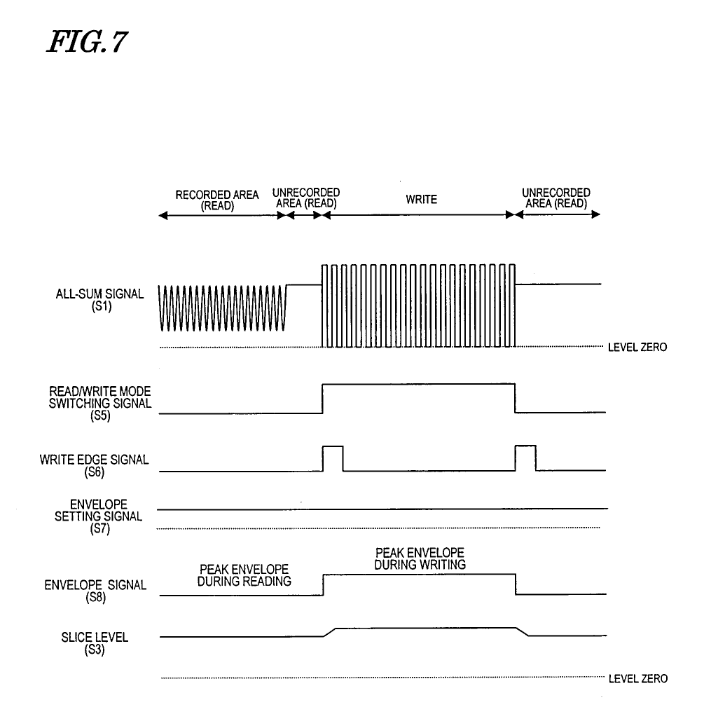

Next, it will be described with reference to FIG. 7 how the dropout detecting section 108 operates if the given optical disc is an H to L type optical disc. FIG. 7 shows the waveforms of main signals for use in the apparatus shown in FIG. 3.

If the given optical disc is an H to L type optical disc, the L to H type recognition signal S9 becomes zero and the envelope setting signal S7 becomes one. As a result, no matter whether the mode of operation is read or write, the envelope detecting section 212 (see FIG. 3) always detects the peak envelope, thus producing a slice level S3 based on the envelope signal S8 at a relatively high level as shown in FIG. 7.

Since the peak envelope level of the all-sum signal obtained from the H to L type optical disc is substantially constant with respect to the intensity of the light reflected from the unrecorded area (i.e., the level of the all-sum signal), the envelope signal S8 is substantially constant, no matter whether the light beam spot is located in a recorded area or in an unrecorded area. That is why even if the given optical disc is an H to L type optical disc, the operations to be performed are substantially the same as a situation where data needs to be written on an L to H type optical disc.

According to this preferred embodiment, even if the level of the all-sum signal S1 shown in FIG. 4 or 7 has decreased locally due to a dropout, the envelope signal S8 will become lower than the slice level S3 to an appropriate degree. As a result, the dropout can be detected properly in any of various situations.

Also, in the preferred embodiment described above, the input signal for the dropout detector 108 is the all-sum signal supplied from the quadruple photodetector. However, as long as the input signal can represent the intensity of the light reflected, the input signal does not have to be the all-sum signal. For example, in an optical disc apparatus that is designed to generate a tracking error signal and a focus error signal using two different photodetectors, the input signal may be the sum signal of one of those two photodetectors. Meanwhile, in an optical disc apparatus including a main detector and a sub-detector to make corrections for the main detector, the input signal may also be the sum signal of the main detector.

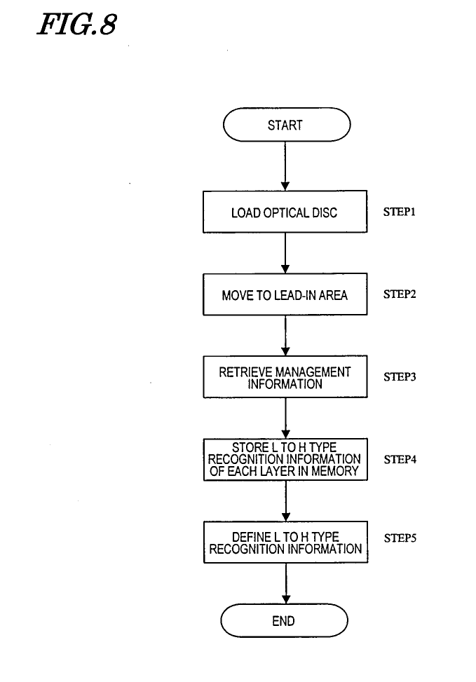

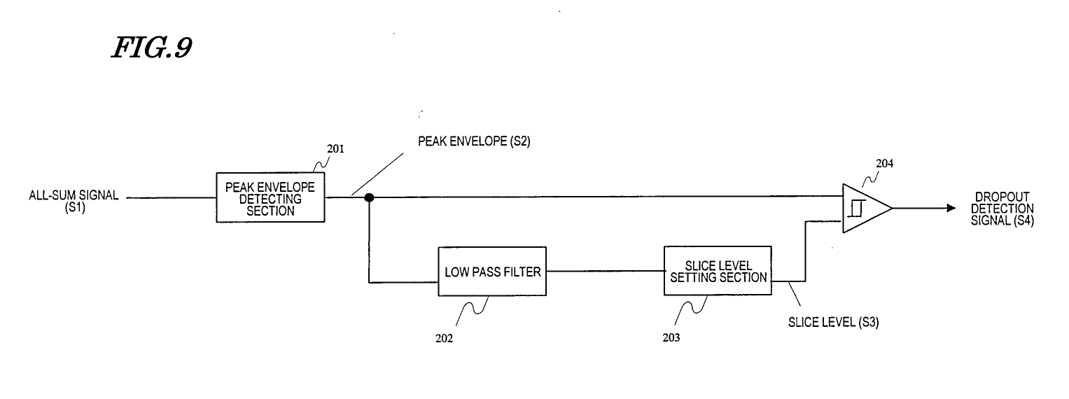

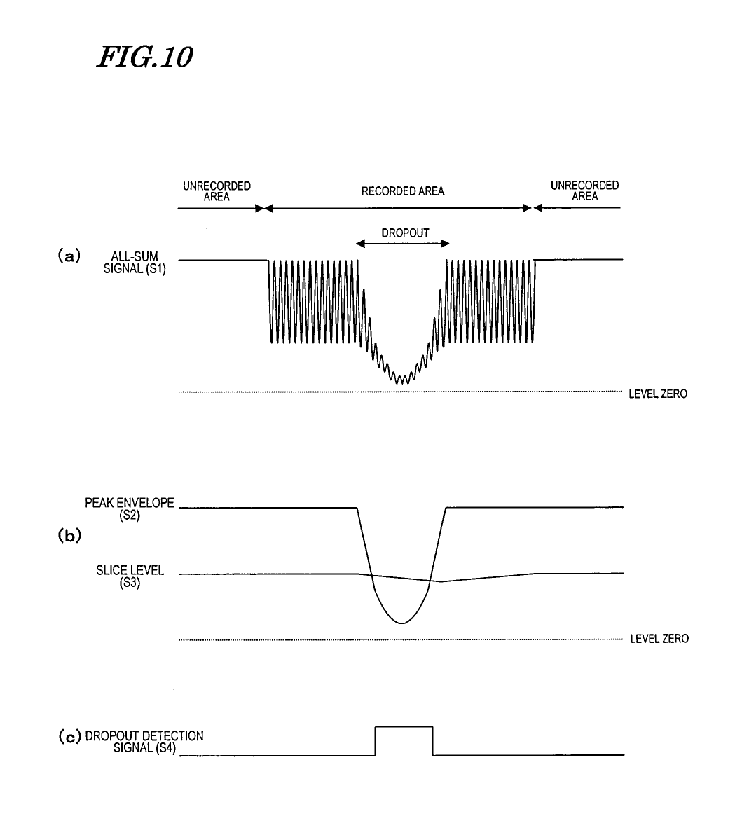

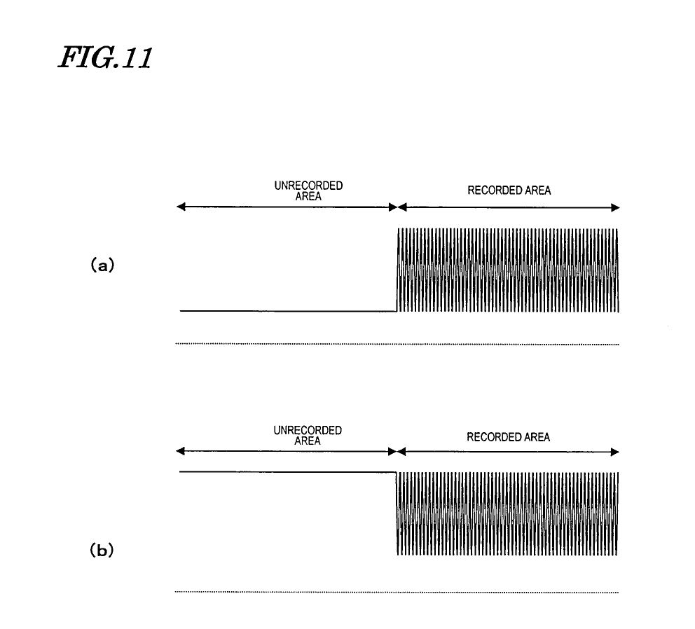

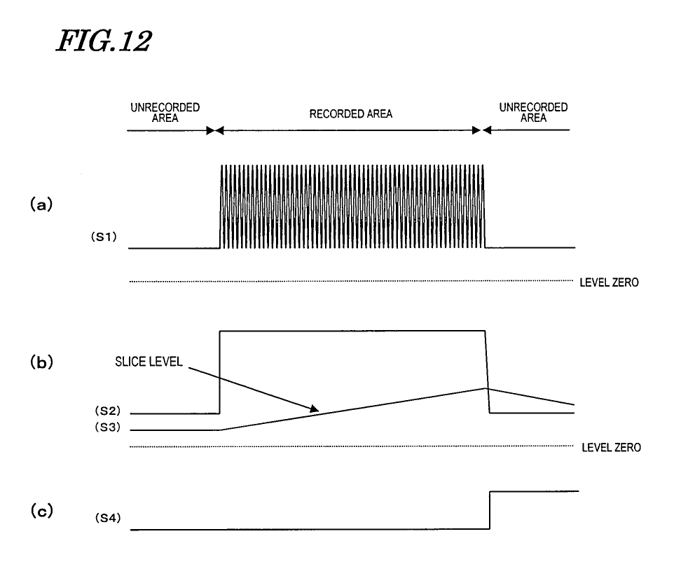

Next, the procedure of processing to be carried out on the optical disc 101 inserted will be described with reference to FIGS. 2 and 8.

First, when the optical disc 101 is inserted into the optical disc apparatus of this preferred embodiment, a disc loading process is carried out on the optical disc 101 in STEP 1 by getting a focus control and a tracking control performed by the focus control section 106 and the tracking control section 105, respectively.

Next, the optical head 102 is moved to the lead-in area as the innermost area on the disc (in STEP 2) and then management information that is stored in advance in the lead-in area is retrieved (in STEP 3).

Thereafter, it is determined, based on the management information thus acquired, whether each of the information storage layers of the given optical disc is an H to L type or an L to H type, and then those pieces of information are stored in the memory 116 of the optical disc apparatus (in STEP 4). In this case, the setting section 103 defines L to H type recognition information at the current location (in STEP 5).

When a read/write operation on the optical disc is started, the setting section 103 shown in FIG. 2 outputs an L to H type recognition signal S9 in accordance with the L to H type recognition information thus obtained. Then, in response to the L to H type recognition signal S9 and the read/write mode switching signal S5 supplied from the controller 114 shown in FIG. 2, the dropout detecting section 108 will select an appropriate slice level setting method according to the situation shown in Table 1.

If the given optical disc is an L to H type optical disc, the slice level for dropout detection can be quickly defined at an appropriate level by performing these processing steps even when the light beam spot is moving from the unrecorded area of the optical disc into the recorded area. As a result, when the light beam spot is moving from the recorded area of the given optical disc into the unrecorded area thereof, the focus and tracking controls can be stabilized without detecting a dropout by mistake.

It should be noted that not only BDs but also HD-DVDs could be processed by the optical disc apparatus of the present invention.

### INDUSTRIAL APPLICABILITY

A dropout detector according to the present invention may be used in various types of optical disc apparatuses. It should be noted that the “optical disc apparatus” broadly refers herein to any type of electronic device that uses an optical disc as a removable storage medium. Thus, examples of such optical disc apparatuses include not just optical disc drives that are supposed to be built in other devices but also consumer electronic devices such as camcorders and optical disc recorders and office automation equipment including data recorders.

1. An optical disc apparatus having the ability to read and/or write data from/on an optical disc on which the data is stored by making a plurality of recording marks on a track, the apparatus comprising:
an optical head that irradiates a given optical disc with a light beam and generates electrical signals based on light reflected from the optical disc;
a dropout detecting section for detecting a dropout that has occurred in the reflected light intensity by comparing the level of one of the electrical signals that represents the reflected light intensity to a slice level; and
a decision section for determining whether each information storage layer of the given optical disc is a first type, in which the recording marks have a higher reflectance than an unrecorded area, or a second type, in which the recording marks have a lower reflectance than the unrecorded area,
wherein either a bottom envelope or a peak envelope of the reflected light intensity is selected in accordance with the decision made by the decision section and the slice level is defined based on the envelope selected.

2. The optical disc apparatus of claim 1, wherein in reading data from a target information storage layer of the given optical disc, if the information storage layer is the first type, the slice level is defined based on the bottom envelope of the reflected light intensity, but
if the information storage layer is the second type, the slice level is defined based on the peak envelope of the reflected light intensity.

3. The optical disc apparatus of claim 2, wherein in writing data on the target information storage layer of the given optical disc, the slice level is always defined based on the peak envelope of the reflected light intensity, no matter whether the information storage layer is the first type or the second type.

4. The optical disc apparatus of claim 1, wherein the dropout detecting section includes:
an envelope detecting section for detecting either the peak envelope or the bottom envelope based on the reflected light intensity to generate an envelope signal representing either the peak envelope or the bottom envelope;
a low pass filter for smoothing the envelope signal;
a slice level setting section for defining a slice level based on the output of the low pass filter; and
a comparator for comparing the level of the envelope signal to the slice level and outputting a dropout detection signal in finding the level of the envelope signal lower than the slice level.

5. The optical disc apparatus of claim 4, wherein the low pass filter includes a time constant changing section for smoothing the envelope signal with different time constants, and
wherein if the envelope detecting section is generating an envelope signal representing the peak envelope, then the time constant changing section temporarily decreases the time constant synchronously with the change of modes of operation from reading into writing, or vice versa.

6. The optical disc apparatus of claim 1, wherein when the dropout detecting section detects a dropout that has occurred in the reflected light intensity, at least one of a focus servo control and a tracking servo control on the information storage layer is put on hold.

7. The optical disc apparatus of claim 5, wherein in a situation where the envelope detecting section is generating an envelope signal representing the peak envelope, even if the level of the envelope signal becomes lower than the slice level, neither the focus servo control nor the tracking servo control on the information storage layer is put on hold during a predetermined period that is synchronized with the changes of modes of operations between reading and writing.

8. The optical disc apparatus of claim 1, wherein if the given optical disc has multiple information storage layers, it is determined, in accordance with the decision made by the decision section, whether a target one of the information storage layers, on which a read/write operation needs to be carried out, is the first type or the second type and the slice levels are defined for the respective information storage layers.

9. A dropout detector for detecting a dropout that has occurred in the intensity of light reflected from an information storage layer of an optical disc by comparing the level of a signal representing the reflected light intensity to a slice level, the detector comprising:
an envelope detecting section for detecting either a peak envelope or a bottom envelope based on the reflected light intensity to generate an envelope signal representing either the peak envelope or the bottom envelope;
a low pass filter for smoothing the envelope signal;
a slice level setting section for defining a slice level based on the output of the low pass filter; and
a comparator for comparing the level of the envelope signal to the slice level and outputting a dropout detection signal in finding the level of the envelope signal lower than the slice level,
wherein in performing a read operation on an information storage layer of a first type, in which recording marks have a higher reflectance than an unrecorded area, the envelope detecting section generates an envelope signal representing the bottom envelope based on the reflected light intensity, but
in performing a read operation on an information storage layer of a second type, in which the recording marks have a lower reflectance than the unrecorded area, the envelope detecting section generates an envelope signal representing the peak envelope based on the reflected light intensity.

10. The dropout detector of claim 9, wherein the low pass filter includes a time constant changing section for smoothing the envelope signal with different time constants, and
wherein if the envelope detecting section is generating an envelope signal representing the peak envelope, then the time constant changing section temporarily decreases the time constant synchronously with the change of modes of operation from reading into writing, or vice versa.
